(19) United States
(12) Patent Application Publication
(10) Pub. No.: US 2012/0080639 A1
(43) Pub. Date: Apr. 5, 2012

(54) POTATO SHAPED GRAPHITE FILLER, THERMAL INTERFACE MATERIALS AND EMI SHIELDING

(75) Inventors: Karen Bruzda, Cleveland, OH (US); Richard F. Hill, Parkman, OH (US)

(73) Assignee: LAIRD TECHNOLOGIES, INC., Chesterfield, MO (US)

(21) Appl. No.: 12/897,309

(22) Filed: Oct. 4, 2010

(51) Int. Cl. C09K 5/00; G21F 1/10

(52) U.S. Cl. 252/70; 252/478

(57) ABSTRACT

Various potato graphite filler, thermal interface materials, EMI shielding materials and methods of making thermal interface and EMI shielding materials are disclosed. An example thermal interface material includes a matrix material and a graphite filler suspended in the matrix material. The graphite filler includes potato graphite particles.

### FIELD

The present disclosure generally relates to graphite filler, thermal interface materials and electromagnetic interference (EMI) shielding.

### BACKGROUND

This section provides background information related to the present disclosure which is not necessarily prior art.

Electrical components, such as semiconductors, transistors, etc., typically have pre-designed temperatures at which the electrical components optimally operate. Ideally, the pre-designed temperatures approximate the temperature of the surrounding air. But the operation of electrical components generates heat which, if not removed, can cause the electrical components to operate at temperatures significantly higher than normal or desirable operating temperature. Such excessive temperatures may adversely affect the operating characteristics of the electrical component and the operation of any associated devices. To avoid or at least reduce the adverse operating characteristics from the heat generation, the heat should be removed, for example, by conducting the heat from the operating electrical components to heat sinks. The heat sinks may then be cooled by conventional convection and/or radiation techniques. During conduction, the heat may pass from the operating electrical components to the heat sinks either by direct surface contact between the electrical components and heat sinks and/or by contact of the electrical components and heat sink surfaces through an intermediate medium or thermal interface material (TIM). The thermal interface material may be used to fill the gap between thermal transfer surfaces, in order to increase thermal transfer efficiency as compared to having the gap filled with air, which is a relatively poor thermal conductor. In some devices, an electrical insulator may also be placed between the electrical component and the heat sink, in many cases this is the TIM itself.

In addition, electronic equipment often generates electromagnetic signals in one portion of the electronic equipment that may radiate to and interfere with another portion of the electronic equipment. This electromagnetic interference (EMI) can cause degradation or complete loss of important signals, thereby rendering the electronic equipment inefficient or inoperable. Sometimes, to reduce the adverse effects of EMI, electrically conducting material is interposed between the two portions of the electronic circuitry for absorbing and/or reflecting EMI energy. This shielding may take the form of a wall or a complete enclosure and may be placed around the portion of the electronic circuit generating the electromagnetic signal and/or may be placed around the portion of the electronic circuit that is susceptible to the electromagnetic signal. For example, electronic circuits or components of a printed circuit board (PCB) are often enclosed with shields to localize EMI within its source, and to insulate other devices proximal to the EMI source.

As used herein, the term electromagnetic interference (EMI) should be considered to generally include and refer to both electromagnetic interference (EMI) and radio frequency interference (RFI) emissions, and the term “electromagnetic” should be considered to generally include and refer to both electromagnetic and radio frequency from external sources and internal sources. Accordingly, the term shielding (as used herein) generally includes and refers to both EMI shielding and RFI shielding, for example, to prevent (or at least reduce) ingress and egress of EMI and RFI relative to a housing or other enclosure in which electronic equipment is disposed.

### SUMMARY

This section provides a general summary of the disclosure, and is not a comprehensive disclosure of its full scope or all of its features.

According to one aspect of the present disclosure, a thermal interface material includes a matrix material and a graphite filler suspended in the matrix material. The graphite filler includes potato graphite particles.

According to another aspect, an electromagnetic interference (EMI) shielding material includes a matrix material and a graphite filler suspended in the matrix material. The graphite filler includes potato graphite particles.

According to yet another aspect of the present disclosure, a thermally conductive and non-electrically conductive thermal interface material includes a matrix material and a potato graphite filler suspended in the matrix material. The potato graphite filler is coated with an electrically insulating coating.

In still another aspect of this disclosure, a method of manufacturing a thermal interface material is disclosed. The method includes coating potato graphite filler with a coating and suspending the coated potato graphite filler in a matrix material.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 depicts a scanning electron microscope photomicrograph of potato graphite with an average diameter of 10 micrometers made in accordance with methods of the present technology.

FIG. 2 depicts a scanning electron microscope photomicrograph of potato graphite with an average diameter of 10 micrometers photographed at a higher magnification compared with FIG. 1, made in accordance with methods of the present technology.

FIG. 3 depicts a scanning electron microscope photomicrograph of potato graphite with an average diameter of 10 micrometers photographed at a higher magnification compared with FIG. 1, made in accordance with methods of the present technology.

FIG. 4 depicts a scanning electron microscope photomicrograph of potato graphite with an average diameter of 10 micrometers photographed at a higher magnification compared with FIGS. 2 and 3, made in accordance with methods of the present technology.

FIG. 5 depicts a scanning electron microscope photomicrograph of potato graphite with an average diameter of 20 micrometers made in accordance with methods of the present technology.

FIG. 6 depicts a scanning electron microscope photomicrograph of potato graphite with an average diameter of 20 micrometers photographed at a higher magnification compared with FIG. 5, made in accordance with methods of the present technology.

FIG. 7 depicts a scanning electron microscope photomicrograph of potato graphite with an average diameter of 20 micrometers photographed at a higher magnification compared with FIGS. 5 and 6, made in accordance with methods of the present technology.

FIG. 8 depicts a scanning electron microscope photomicrograph of potato graphite with an average diameter of 50 micrometers made in accordance with methods of the present technology.

FIG. 9 depicts a scanning electron microscope photomicrograph of potato graphite with an average diameter of 50 micrometers photographed at the same magnification compared with FIG. 8, made in accordance with methods of the present technology.

FIG. 10 depicts a scanning electron microscope photomicrograph of potato graphite with an average diameter of 50 micrometers photographed at a higher magnification compared with FIGS. 8 and 9, made in accordance with methods of the present technology.

FIG. 11 depicts a scanning electron microscope photomicrograph of potato graphite with an average diameter of 50 micrometers photographed at a higher magnification compared with FIG. 10, made in accordance with methods of the present technology.

FIG. 12 depicts a scanning electron microscope photomicrograph of potato graphite with an average diameter of 70 micrometers made in accordance with methods of the present technology.

FIG. 13 depicts a scanning electron microscope photomicrograph of potato graphite with an average diameter of 70 micrometers photographed at the same magnification compared with FIG. 12, made in accordance with methods of the present technology.

FIG. 14 depicts a scanning electron microscope photomicrograph of potato graphite with an average diameter of 70 micrometers photographed at a higher magnification compared with FIGS. 12 and 13, made in accordance with methods of the present technology.

FIG. 15 depicts a scanning electron microscope photomicrograph of potato graphite with an average diameter of 70 micrometers photographed at the same magnification compared with FIG. 14, made in accordance with methods of the present technology.

FIG. 16 depicts a scanning electron microscope photomicrograph of potato graphite with an average diameter of 70 micrometers photographed at a higher magnification compared with FIG. 15, made in accordance with methods of the present technology.

FIG. 17 depicts a scanning electron microscope photomicrograph of a primarily synthetic graphite.

FIG. 18 depicts another scanning electron microscope photomicrograph of a primarily synthetic graphite.

FIG. 19 is a graph of thermal conductivity as a function of loading by percent by volume for thermal interface materials using several different filler materials.

FIG. 20 is a graph of measured thermal conductivity of various thermal interface materials using different types of graphite filler as a function of amount of filler by percent volume.

FIG. 21 depicts a scanning electron microscope photomicrograph of potato graphite with an average diameter of 20 micrometers coated with 100 cycles of aluminum oxide by atomic layer deposition (ALD), made in accordance with methods of the present technology.

FIG. 22 depicts a scanning electron microscope photomicrograph of potato graphite with an average diameter of 20 micrometers coated with 100 cycles of aluminum oxide by ALD photographed at a higher magnification compared with FIG. 21, made in accordance with methods of the present technology.

FIG. 23 depicts a scanning electron microscope photomicrograph of potato graphite with an average diameter of 20 micrometers coated with 100 cycles of aluminum oxide by ALD photographed at a higher magnification compared with FIG. 22, made in accordance with methods of the present technology.

FIG. 24 depicts a scanning electron microscope photomicrograph of potato graphite with an average diameter of 20 micrometers coated with 100 cycles of aluminum oxide by ALD photographed at the same magnification compared with FIG. 23, made in accordance with methods of the present technology.

FIG. 25 depicts a scanning electron microscope photomicrograph of potato graphite with an average diameter of 20 micrometers coated with 100 cycles of aluminum oxide by ALD photographed at the same magnification compared with FIG. 24, made in accordance with methods of the present technology.

FIG. 26 is a table comparing measured electrical resistance and calculated resistivity for 20 micrometer uncoated potato graphite and 20 micrometer potato graphite coated with 100 cycles of aluminum oxide by ALD, made in accordance with methods of the present technology.

### DETAILED DESCRIPTION

Example embodiments will now be described more fully with reference to the accompanying drawings.

Graphite is commonly used as heat conductive filler material. But the inventors hereof have disclosed graphite particles or fillers that are spherical to potato shaped (e.g., spherical, semi-spherical, roundish, etc.) suitable for use as a thermally conductive filler in thermal management applications and/or as an electrically-conductive filler for EMI shielding applications. The inventors have recognized a need for graphite fillers, which have relatively high thermal conductivity and/or electrical conductivity, can be loaded into a matrix at high levels, and are relatively low cost. Lubricity of graphite is an added bonus in various exemplary embodiments (making it, for example, easier to flow). By way of example, the inventors' graphite filler may be used in thermal gap pads, thermal greases, phase change materials, etc. In some examples, the graphite may have a median particle diameter D50 in the range of about 10 to 70 microns.

While current graphite fillers may be in the form of fibers, flakes, needles, grains, “lumps”, etc., the inventors have recognized that these graphite shapes may suffer from drawbacks that prevent these particular graphite fillers from being extremely useful as fillers in some thermal management applications, such as when either resin demand is high, the particular shape prevents high loading, and/or the finished material is very hard. The inventors' use of spherical to potato shaped graphite may provide the advantage of being spherical to semi-spherical, such that surface area is generally lower than other morphologies and particle packing technology can be used to achieve higher loading. Particle packing is the process of “nesting” specific size distributions of fillers in the voids formed between other fillers of a different specific size distribution as they touch each other. For this practice, it is useful for the fillers to be substantially spherical and regularly sized so that predictably sized voids will exist between the point contacts of the fillers. These voids can then be filled with another filler of a specific size distribution. The packing process may continue for several iterations. Additionally, the rounded shape of such particles may allow potato graphite to flow easier and pack better than graphite particles of other shapes. At relatively high loadings, the spherical to semi-spherical graphite may allow finished pads to remain relatively compliant.

By way of comparison to boron nitride (which is sometimes used as a thermally conductive filler), the inventors' have recognized that spherically shaped boron nitride particles are extremely expensive as compared to the inventors' spherical to potato shaped graphite.

In comparison to aluminum oxide (which is sometimes used as a thermally conductive filler), spherical to potato shaped graphite is priced by weight on par with some aluminum oxides, but spherical to potato shaped graphite has a lower density such that less weight is needed for equivalent volume loads. Also, the inventors have recognized that spherical to potato shaped graphite tends to be less abrasive and more thermally conductive than aluminum oxide. For example, potato shaped graphite may have thermal conductivity of greater than 500 watts per meter Kelvin (W/(m·K)) in some direction parallel to the planar crystal structure, while aluminum oxides may have a thermal conductivity in the range of 20 to 33 W/(m·K).

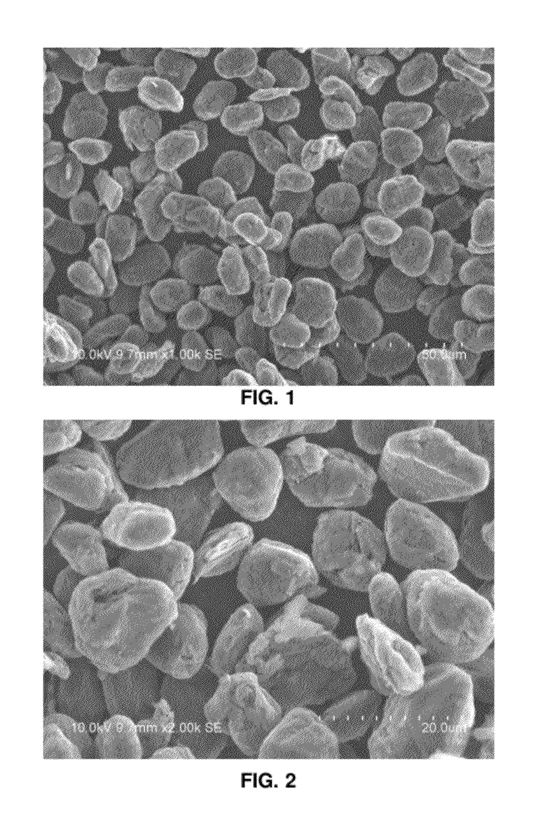

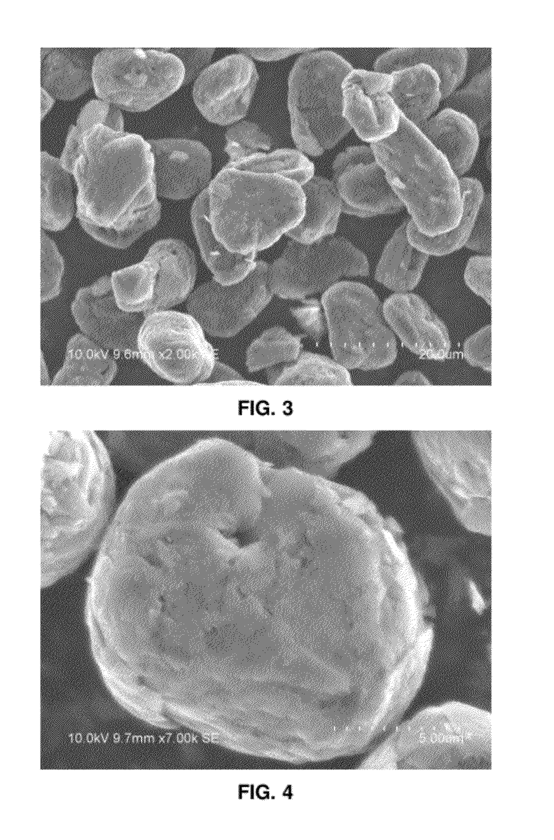

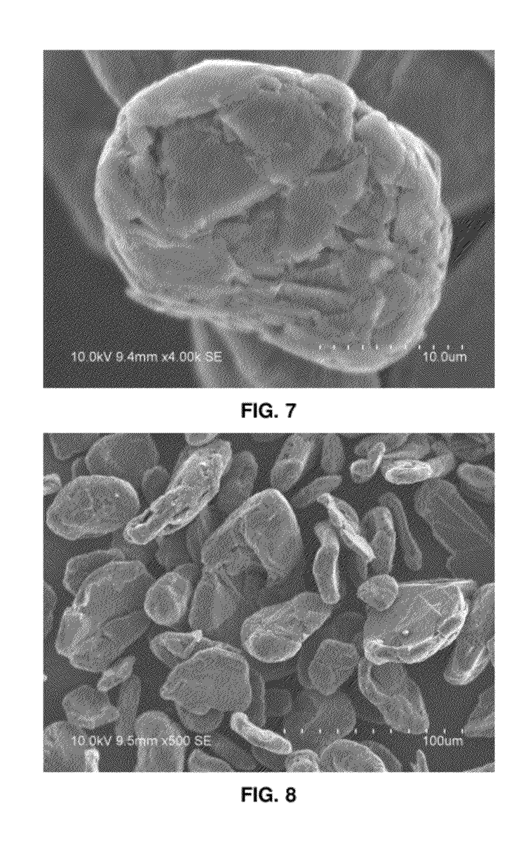

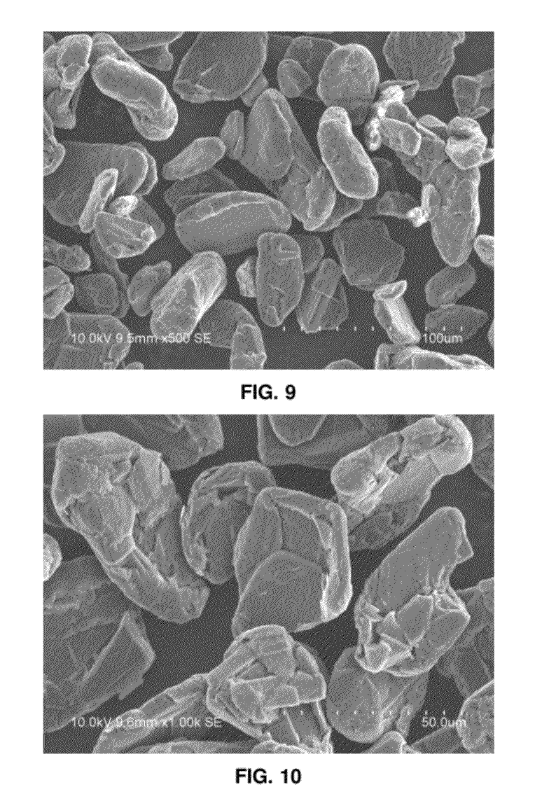

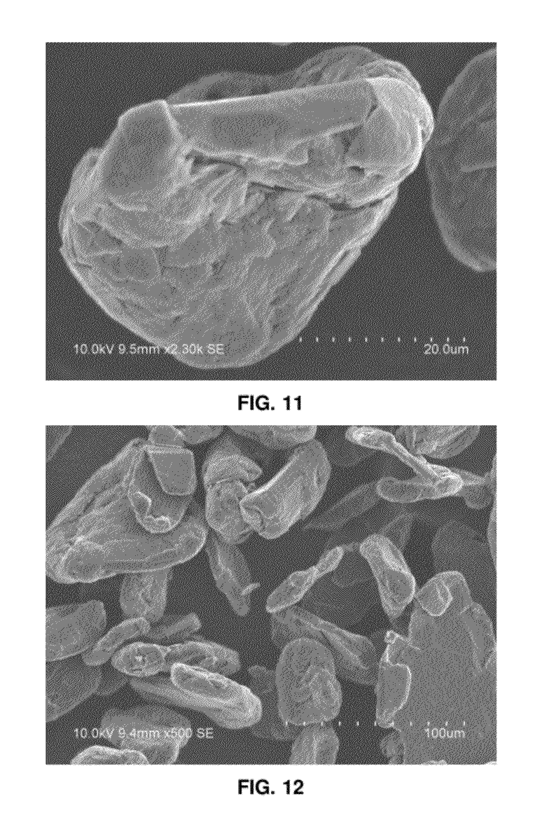

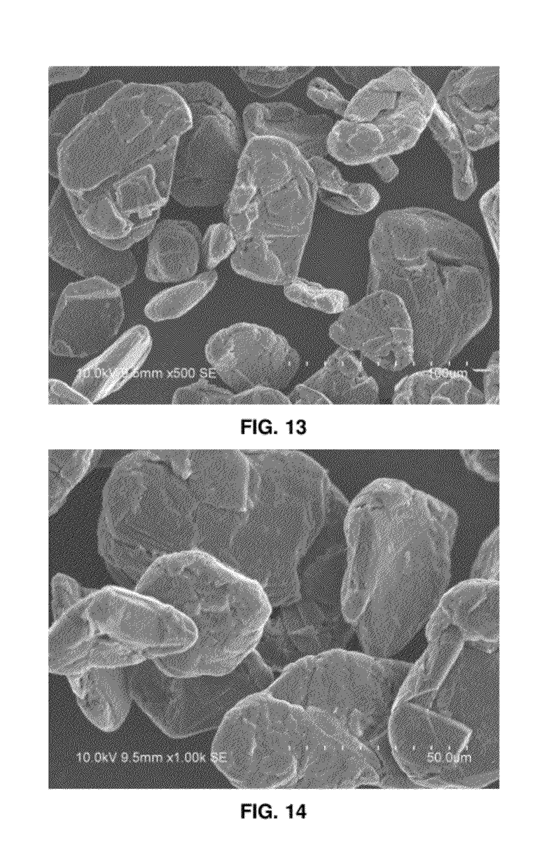

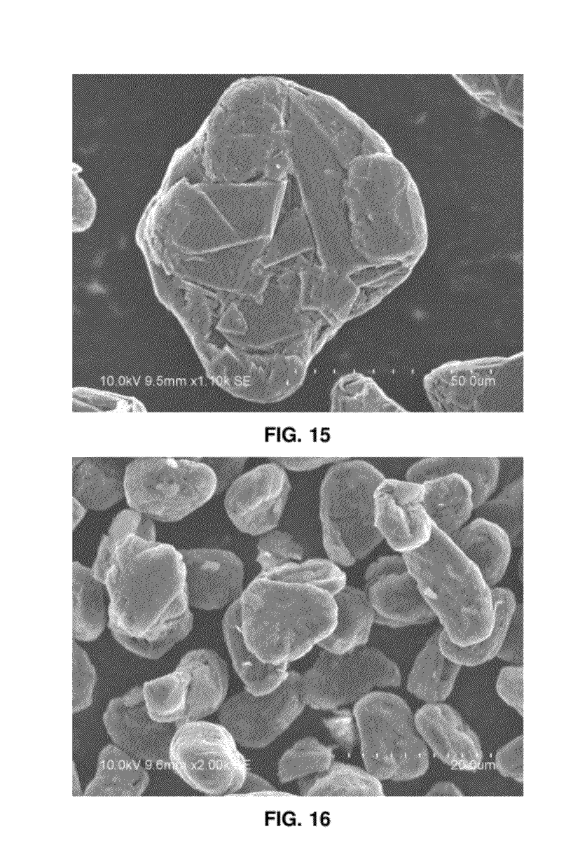

The term “potato graphite” will be used herein to describe graphite processed to increase the spherocity of the graphite. The process may be practiced on natural (e.g., vein graphite) or artificial graphite (e.g., highly crystalline synthetic graphite). Prior to processing, the graphite is commonly scaly (e.g., plate like) or flake graphite having a relatively high degree of crystallinity. The graphite is processed by milling, rolling, grinding, compressing, deforming, etc. the graphite to bend, fold, shape, form, etc. the flakes into a roughly spherical shape. This process may increase the isotropic properties of the graphite over the more anisotropic flake form of the graphite. FIGS. 1 through 16 illustrate some examples of “potato graphite” resulting from such a process.

The term “potato graphite” is also used herein to describe graphite having a shape that is typically produced by the process described above (whether produced by such process, by another process or processes, naturally occurring, etc.). “Potato graphite” commonly ranges in shape from the shape of a potato to almost spherical. “Potato graphite” is typically elongated, oblong, etc. and may include graphite having an ellipsoid shape, an ovoid shape, a rectangular shape, an oblate spheroid shape, etc. FIGS. 1 through 16 illustrate numerous examples of “potato graphite”. Both “potato graphite” overall and individual particles of “potato graphite” do not necessarily have a uniform shape and do not necessarily have a symmetrical shape. As used herein, the term “potato graphite” is intended to encompass graphite produced by the process described above, graphite having the shapes as explained in this paragraph, and graphite as illustrated in FIGS. 1 through 16, without limitation unless otherwise expressly noted.

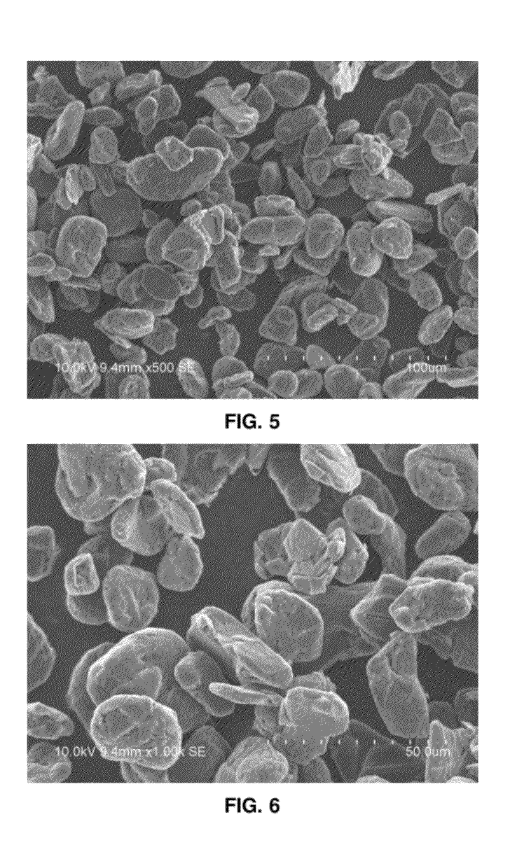

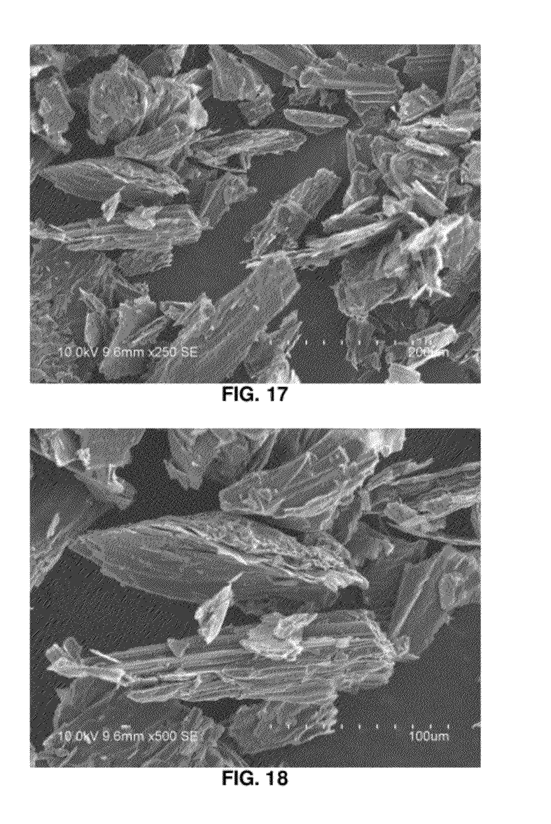

Various examples of potato graphite are illustrated in FIGS. 1-16. Each of FIGS. 1-16 depicts a scanning electron microscope photomicrograph of potato graphite made in accordance with methods of the present technology. More specifically, the potato graphite in FIGS. 1-4 has an average diameter of 10 micrometers. The potato graphite in FIGS. 5-7 has an average diameter of about 20 micrometers. The potato graphite in FIGS. 8-11 has an average diameter of about 50 micrometers. The potato graphite in FIGS. 12-16 has an average diameter of about 70 micrometers. FIGS. 17 and 18 depict scanning electron microscope photomicrographs of some primarily synthetic graphite that is not potato graphite for comparison.

Potato graphite as disclosed herein may be used as a filler for thermal interface materials. The potato graphite according to various embodiments may be similar to that depicted in FIGS. 1-16, and/or may have larger or smaller average diameters than those depicted in FIGS. 1-16.

According to one aspect of the present disclosure, a thermal interface material includes a matrix material and a graphite filler suspended in the matrix material. The graphite filler includes potato graphite particles.

The thermal interface material may include a thermally-conductive compliant material, a thermal interface/phase change material, a gap filler, a thermal putty, a thermal grease, etc.

The matrix material in various embodiments of the thermal interface material may be a resin matrix material. The resin matrix material may include a silicone resin, an oil-gel resin, etc. In various embodiments, the matrix material may be a wax or a polyurethane.

In an exemplary embodiment of a thermal interface material, the median particle diameter D50 of the graphite filler is between about 5 micrometers and 300 micrometers. In another exemplary embodiment, the median particle diameter D50 of the graphite filler is between about 5 micrometers and 100 micrometers. In yet another exemplary embodiment, the median particle diameter D50 of the graphite filler is between about 5 micrometers and 70 micrometers. These ranges of median particle diameter D50 for the graphite filler are not exhaustive and the graphite filler may have a median particle diameter outside the ranges identified herein.

The amount of graphite filler suspended in the matrix material may be varied depending on the desired characteristics of the thermal interface material and the presence (or absence) of other fillers. The amount of graphite filler can vary from a low level (e.g., 1-2% by volume) if other fillers are present and heavily relied upon, to high level (e.g., >80% by volume) if the graphite is highly spherical and of very controlled size distribution. In an example embodiment, the graphite filler is between about 15 percent and 60 percent by volume.

In various exemplary embodiments, the thermal interface material may have a minimum thermal conductivity of about ½ W/(m·K).

In various embodiments, the thermal interface material may include an additional filler. The additional filler may include, for example, aluminum, aluminum oxide, boron nitride, zinc oxide, or aluminum nitride. The additional filler may be the same size and/or be a different size (or sizes) than the potato graphite used as the first filler.

In exemplary embodiments of a thermal interface material, the graphite filler may include one or more types of graphite particles that are not potato graphite. The graphite particles that are not potato graphite may include fibers, flakes, needles, grains, “lumps”, etc. The non-potato graphite may be the same size and/or be a different size (or sizes) than the potato graphite.

Similarly, the graphite filler may include one size of graphite filler or more than one size of graphite filler. When more than one size of graphite filler is used, the different sized graphite may be of the same type or may be of different types. A size of graphite does not require that all particles of that size of graphite be identical size, but instead that the graphite is categorized as a particular size according to known methods. A size of graphite will typically include graphite particles that will vary about the identified/categorized size.

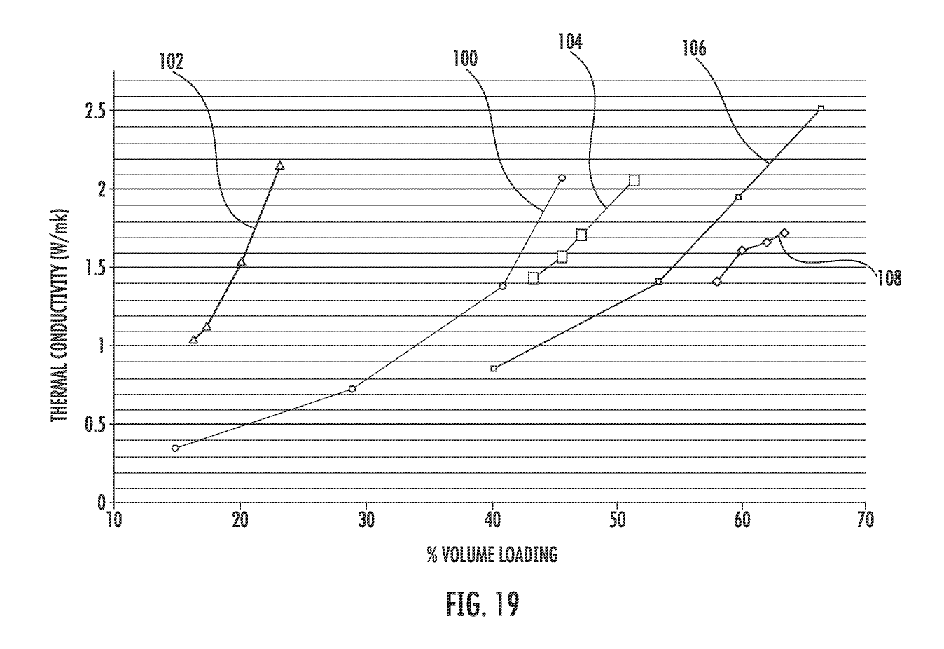

FIG. 19 graphically illustrates the measured thermal conductivity of various thermal interface materials using different fillers as a function of amount of filler by percent volume. Each thermal interface material includes a mono-modal distribution of filler. The thermal conductivity for potato graphite having about a 20 micrometer diameter can be seen at line 100. Line 102 illustrates the thermal conductivity for a thermal interface material using boron nitride. The thermal conductivity for a thermal interface material using zinc oxide is shown by line 104. Line 106 illustrates the thermal conductivity for a thermal interface material using aluminum. The thermal conductivity of a thermal interface material using alumina is shown by line 108. All of the fillers in the thermal interface materials represented in FIG. 19 have an average size of about 20 micrometers and are relatively spherical in shape. For the amounts of filler shown in FIG. 19, potato graphite (at line 100) provides higher thermal conductivity for the same volume of filler (or conversely requires a lower volume of filler for the same thermal conductivity) than all of the other example fillers except boron nitride (at line 102).

In addition to providing high thermal conductivity for a given volume of filler, potato graphite is also relatively inexpensive. To achieve the highest thermal conductivity illustrated in FIG. 19, the cost per liter of formula for each of the boron nitride, aluminum oxide, and aluminum based thermal interface materials was more than 4.5 times the cost per liter of formula for potato graphite based material. The cost per liter for the material using zinc was more than 10 times the cost per liter of formula for potato graphite based material.

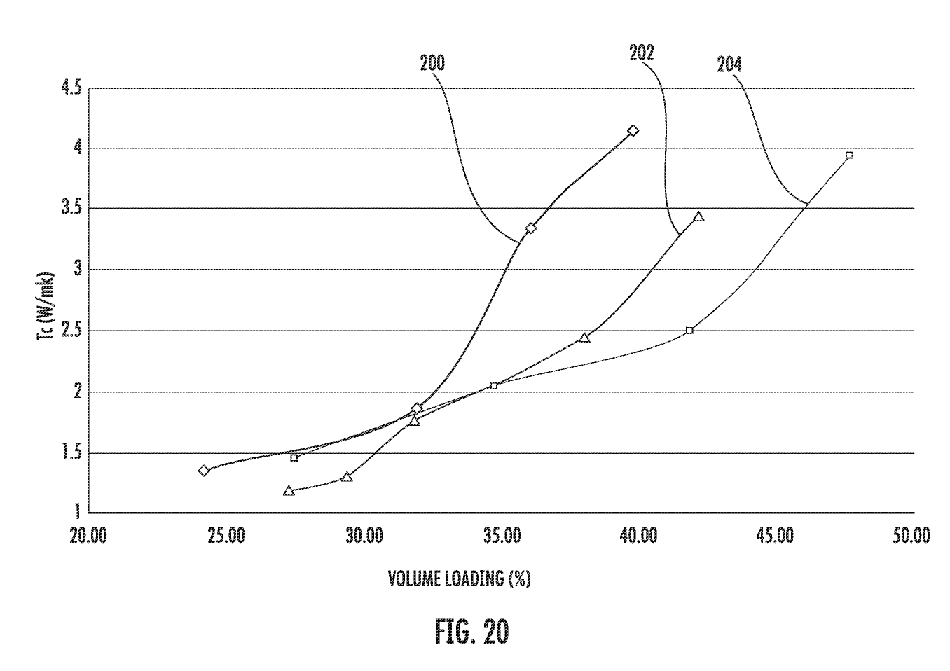

FIG. 20 graphically illustrates the measured thermal conductivity of various thermal interface materials using different types of graphite filler as a function of amount of filler by percent volume. The thermal conductivity for potato graphite having about a 70 micrometer diameter can be seen at line 200. Line 202 shows the thermal conductivity for a thermal interface material using 70 micrometer irregular (i.e., not processed to increase spherocity). Line 204 shows the thermal conductivity for a thermal interface material using graphite fibers having a length of 70 micrometers. Throughout most of the range of volume loadings represented in FIG. 20, the potato graphite (line 200) provides a higher thermal conductivity for the same volume of filler (or conversely requires a lower volume of filler for the same thermal conductivity) than both the irregular vein graphite (line 202) and the graphite fibers (line 204).

In addition to providing high thermal conductivity for a given volume of filler within a matrix and filler mixture, potato graphite is also relatively inexpensive. To achieve the highest thermal conductivity illustrated in FIG. 20, the cost per liter of formula for 70 micrometer length graphite fiber based thermal interface material was more than five times the cost per liter of formula for the potato graphite based material with the highest thermal conductivity. Despite the reduced volume cost, the thermal interface material including potato graphite filler exhibited higher thermal conductivity than the thermal interface material including the graphite fiber. The cost per liter for the material using irregular vein graphite was slightly cheaper (about two percent) than the cost per liter of formula for potato graphite based material. However, the thermal interface material made with potato graphite filler yielded higher thermal conductivity than the irregular vein graphite material for the same volume loading. Furthermore, although the example formulations described herein employ a single filler loading system, particle packing technology would likely be useful to optimize the thermal interface material formulations for commercialization. While such particle packing techniques may be used with potato graphite, irregular vein graphite typically is unable to participate optimally in particle packing technology, due (at least in part) to its irregular shape.

In addition to being thermally conductive, graphite, including potato graphite, is electrically conductive. Accordingly, potato graphite may be used as filler in electromagnetic interference (EMI) shielding materials. According to one aspect of the present disclosure, EMI shielding material includes a matrix material and a graphite filler suspended in the matrix material. The graphite filler includes potato graphite particles.

The matrix material in various embodiments of an EMI shielding material may be a resin matrix material. The resin matrix material may include a silicone resin, an oil-gel resin, etc. In various embodiments, the matrix material may be a wax or a polyurethane.

In an exemplary embodiment of an EMI shielding material, the median particle diameter D50 of the graphite filler is between about 5 micrometers and 300 micrometers. In another exemplary embodiment, the median particle diameter D50 of the graphite filler is between about 5 micrometers and 100 micrometers. In yet another exemplary embodiment, the median particle diameter D50 of the graphite filler is between about 5 micrometers and 70 micrometers. These ranges of median particle diameter D50 for the graphite filler are not exhaustive and the graphite filler may have a median particle diameter outside the ranges identified herein.

The amount of graphite filler suspended in the matrix material may be varied depending on the desired characteristics of the EMI shielding material and the presence (or absence) of other fillers. The amount of graphite filler can vary from a low level (e.g., 1-2% by volume) if other fillers are present and heavily relied upon, to high level (e.g., >80% by volume) if the graphite is highly spherical and of very controlled distribution. In an example embodiment of an EMI shielding material, the graphite filler is between about 15 percent and 50 percent by volume.

In exemplary embodiments of an EMI shielding material, the graphite filler may be any suitable graphite filler. The graphite filler may consist of a single type of graphite (e.g., the potato graphite), or may include two or more different types of graphite. For example, the graphite filler may include two or more types of graphite selected from potato graphite, flake graphite, graphite fibers, graphite needles, graphite grains, graphite “lumps”, etc.

Similarly, the graphite filler may include one size of graphite filler or more than one size of graphite filler. When more than one size of graphite filler is used, the different sized graphite may be of the same type or may be of different types. A size of graphite does not require that all particles of that size of graphite be identical size, but instead that the graphite is categorized as a particular size according to known methods. A size of graphite will typically include graphite particles that will vary about the identified size.

The EMI shielding material may include an additional filler suspended in the matrix material. The additional material may be any suitable filler material for EMI shielding purpose including, for example, silver, nickel, silver coated glass, copper coated graphite, etc. As with the graphite filler, the additional filler may consist of a single type of filler (e.g., only silver, only nickel, etc.) or may include two or more types of filler. The additional filler may include particles of a single size, or particles of two or more sizes.

When using thermally conductive fillers that are also electrically conductive (including, e.g., graphite, aluminum, etc.) in thermal interface materials, high loadings of such electrically conductive fillers generally decrease the electrical resistivity of the material and, accordingly, increase the electrical conductivity of the thermal interface material. Such increase in electrical conductivity is typically desirable in EMI shields and sometimes not desirable in thermal interface materials.

The inventors have realized that it may be beneficial to coat electrically and thermally conductive potato graphite with an electrically insulating coating. The inventors have realized that by coating the potato graphite with an electrically non-conductive coating, more potato graphite filler may be used (higher loadings) in a thermal interface material while maintaining the same (or better) electrical properties achievable with an uncoated potato graphite filler. Conversely, if coated potato graphite filler is used to replace uncoated potato graphite filler in a thermal interface material in an equal amount (the same loading), the electrical properties of the thermal interface material may be improved (e.g., less conductive, higher resistance, etc.).

Any suitable method of coating the graphite filler may be used including, for example, chemical vapor deposition (CVD), atomic layer deposition (ALD), plasma vapor deposition (PVD), chemical precipitation, liquid infiltration, fluidized bed, etc. The thickness of the coating may range from a single monatomic layer to any suitable thickness. The coating may have any suitable degree of continuity including, for example, a fully continuous coating.

The electrically insulating coating may be any suitable electrically insulating material. For example, the electrically insulating coating may be boron nitride, aluminum oxide, etc. In various embodiments, the electrically insulating coating may be thermally conductive. For example, the coating may be boron nitride, aluminum oxide, etc.

According to one aspect of the present disclosure a thermally conductive and non-electrically conductive thermal interface material is disclosed. The thermal interface material includes a matrix material and a graphite filler suspended in the matrix material. The graphite filler is coated with an electrically insulating coating.

The thermal interface material may include a thermally-conductive compliant material, a thermal interface/phase change material, a gap filler, a thermal grease, etc.

The matrix material in various embodiments may be a resin matrix material. The resin matrix material may include a silicone resin, an oil-gel resin, etc. In various embodiments, the matrix material may be a wax or a polyurethane.

The graphite filler may be any suitable graphite filler including, for example, potato graphite. The graphite filler may consist of a single type of graphite (e.g., the potato graphite), or may include two or more different types of graphite. For example, the graphite filler may include two or more types of graphite selected from potato graphite, flake graphite, graphite fibers, graphite needles, graphite grains, graphite “lumps”, etc.

Similarly, the graphite filler may include one size of graphite filler or more than one size of graphite filler. When more than one size of graphite filler is used, the different sized graphite may be of the same type or may be of different types. A size of graphite does not require that all particles of that size of graphite be identical size, but instead that the graphite is categorized as a particular size according to known commercial methods. A size of graphite will typically include graphite particles that will vary about the identified size.

In exemplary embodiments, the median particle diameter D50 of the graphite filler is between about 5 micrometers and 300 micrometers. In another embodiment, the median particle diameter D50 of the graphite filler is between about 5 micrometers and 100 micrometers. In yet another embodiment, the median particle diameter D50 of the graphite filler is between about 5 micrometers and 70 micrometers. These ranges of median particle diameter D50 for the graphite filler are not exhaustive and the graphite filler may have a median particle diameter outside the ranges identified herein.

The amount of graphite filler suspended in the matrix material may be varied depending on the desired characteristics of the thermal interface material and the presence (or absence) of other fillers. The amount of graphite filler can vary from a low level (e.g., 1-2% by volume) if other fillers are present and heavily relied upon, to high level (e.g., >80% by volume) if the graphite is highly spherical and of very controlled distribution. In an example embodiment, the graphite filler is between about 15 percent and 60 percent by volume.

In various embodiments, the thermal interface material may include an additional filler. The additional filler may include, for example, aluminum, alumina, boron nitride, zinc oxide, aluminum nitride. The additional filler may be coated with a nonconductive coating or may be uncoated. The additional filler may be the same size and/or be a different size (or sizes) than the potato graphite used as the first filler.

The electrically insulating coating may be any suitable electrically insulating material. For example, the electrically insulating coating may be boron nitride, alumina, silica, calcium carbonate, aluminum trihydrate, a ceramic, etc. In various embodiments, the electrically insulating coating may be thermally conductive. For example, the coating may be boron nitride, aluminum nitride, etc.

In some embodiments, the thermal interface material has a thermal conductivity of between about one-half W/(m·K) and twenty W/(m·K). In other embodiments, the thermal interface material has a thermal conductivity between about one-half W/(m·K) and ten W/(m·K).

Thermal interface materials according to the aspects discussed above may include high loadings of electrically conductive fillers without having unwanted electrical conductivity. Thus, thermal conductivity may be increased beyond what may be achieved using uncoated, electrically conductive fillers while still maintaining electrical conductivity and price at a desired low level. The coating also affects the surface characteristics of the fillers. This may reduce the surface area of the filler, allowing more filler to be used in a thermal interface material. Further, the coated fillers may reduce resin demand allowing more filler to be use with less resin required.

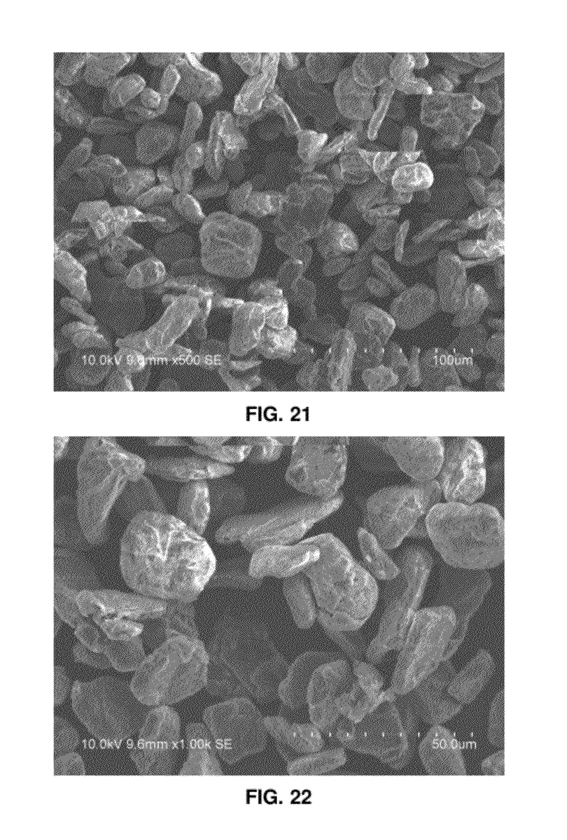

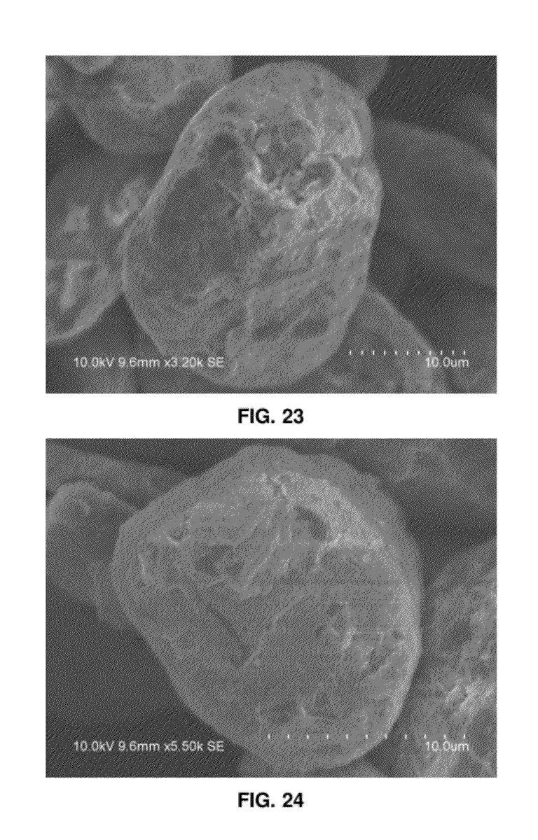

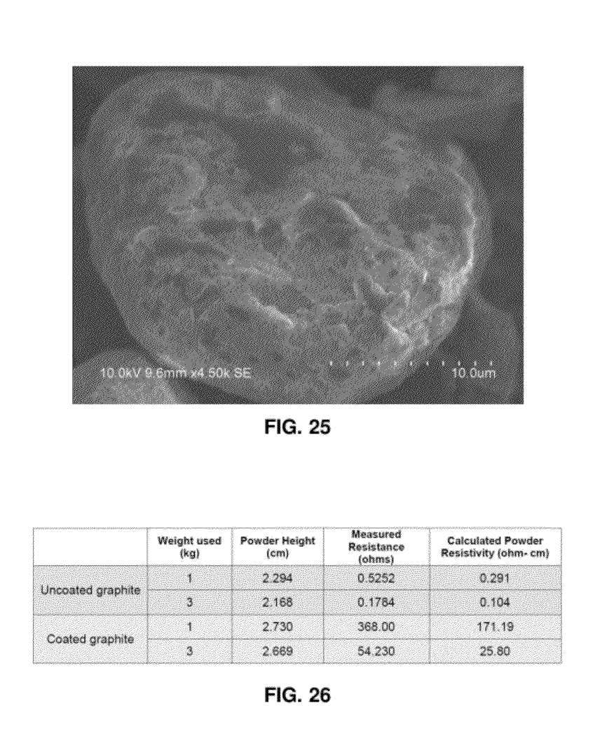

Various examples of potato graphite coated with aluminum oxide are illustrated in FIGS. 21-25. Each of FIGS. 21-25 depicts a scanning electron microscope photomicrograph of the coated potato graphite made in accordance with methods of the present technology. The potato graphite in FIGS. 21-25 has an average diameter of 20 micrometers and was coated with 100 cycles of aluminum oxide coating by atomic layer deposition (ALD) process.

As mentioned previously, graphite is both electrically and thermally conductive. Aluminum oxide, however, is electrically non-conductive and thermally conductive. A sample of 20 micrometer potato graphite was coated with 100 cycles of aluminum oxide coating by ALD (e.g., the potato graphite in FIGS. 21-25). Electrical resistivity of the coated potato graphite was tested and compared to uncoated 20 micrometer potato graphite. The results of this testing are displayed in the table shown in FIG. 26. As can be seen, the coated potato graphite had a significantly higher electrical resistivity than the uncoated potato graphite.

Some fillers have surface characteristics that may be harmful to a matrix material in which they are to be suspended. For example, potato graphite, fiber graphite, and fine alumina may include impurities on their surfaces that are detrimental to some matrix materials. The surface impurities may inhibit and/or prevent curing of some matrix materials, including, for example, silicone resin matrix materials. One method of handling fillers with surface impurities involves high temperature exposure to remove the surface impurities. The inventors have realized that coating fillers with an electrically insulating coating may seal in any impurities and allow such fillers to be used in a thermal interface material without (or with reduced) detrimental affects of the impurities on the matrix material.

For example, some common matrix materials (e.g., for thermal interface materials) include silicones that are platinum catalyzed, addition cure systems. These systems can be easily poisoned (cure inhibited) by contaminants (e.g., amines, tins, sulfur compounds, etc.) on the fillers. In one test, twenty micrometer diameter potato graphite was loaded into such a silicone resin at a volume load of approximately forty percent. After the normal vulcanization (cure) step, the system was still substantially a liquid with no appreciable increase in viscosity. An increase in viscosity would typically have been seen at that time if the addition cure process had proceeded normally. In contrast, another test used twenty micrometer potato graphite which had been coated with 100 cycles of aluminum oxide by the ALD process (e.g., the potato graphite in FIGS. 21-25) in such a silicone resin at a volume load of approximately forty percent. After the cure step, the material had appreciable tensile strength and formed a solid pad.

According to one aspect of the present disclosure, a method of manufacturing a thermal interface material using a filler including surface impurities detrimental to a matrix material of the thermal interface material is disclosed. The method includes coating the filler with a coating and suspending the coated filler in the matrix material.

In exemplary embodiments of such a method, the coating may be any suitable material including, for example, boron nitride, aluminum oxide, zinc oxide, silica, calcium carbonate, aluminum trihydrate, a ceramic, etc. In various embodiments, the coating may be thermally conductive. And, thermal interface material may include a thermally-conductive compliant material, a thermal interface/phase change material, a gap filler, a thermal grease, etc. Also, the matrix material may be a resin matrix material. The resin matrix material may include a silicone resin, an oil-gel resin, etc. In various embodiments, the matrix material may be a wax or a polyurethane.

The filler may be any type of filler. In various embodiments of a method of making a thermal interface material, the filler is a thermally conductive filler. The thermally conductive filler may be, for example, a graphite filler. The graphite filler may consist of a single type of graphite (e.g., potato graphite), or may include two or more different types of graphite. For example, the graphite filler may include two or more types of graphite selected from potato graphite, flake graphite, graphite fibers, graphite needles, graphite grains, graphite “lumps”, etc. Similarly, the graphite filler may include one size of graphite filler or more than one size of graphite filler. When more than one size of graphite filler is used, the different sized graphite may be of the same type or may be of different types. A size of graphite does not require that all particles of that size of graphite be identical size, but instead that the graphite is categorized as a particular size according to known commercial methods. A size of graphite will typically include graphite particles that will vary about the identified size.

In exemplary embodiments, the median particle diameter D50 of the filler is between about 5 micrometers and 300 micrometers. In another embodiment, the median particle diameter D50 of the filler is between about 5 micrometers and 100 micrometers. In yet another embodiment, the median particle diameter D50 of the filler is between about 5 micrometers and 70 micrometers. These ranges of median particle diameter D50 for the filler are not exhaustive and the filler may have a median particle diameter outside the ranges identified herein.

In various embodiments, the thermal interface material may include an additional filler and the method may further comprise suspending the additional filler in the matrix material. The additional filler may include, for example, aluminum, aluminum oxide, boron nitride, zinc oxide, aluminum nitride. The additional filler may be coated or may be uncoated. The additional filler may be the same size and/or be a different size (or sizes) than the filler.

In some embodiments, the thermal interface material has a thermal conductivity of between about one-half W/(m·K) and twenty W/(m·K). In other embodiments, the thermal interface material has a thermal conductivity between about one-half W/(m·K) and ten W/(m·K).

Numerical dimensions and values are provided herein for illustrative purposes only. The particular dimensions and values provided are not intended to limit the scope of the present disclosure.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter. The disclosure of a first value and a second value for a given parameter can be interpreted as disclosing that any value between the first and second values could also be employed for the given parameter. Similarly, it is envisioned that disclosure of two or more ranges of values for a parameter (whether such ranges are nested, overlapping or distinct) subsume all possible combination of ranges for the value that might be claimed using endpoints of the disclosed ranges.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A thermal interface material comprising:
a matrix material; and
a graphite filler suspended in the matrix material, the graphite filler comprising potato graphite particles.

2. The thermal interface material of claim 1 wherein the matrix material includes a resin matrix material.

3. The thermal interface material of claim 2 wherein the resin matrix material includes a silicone resin and/or an oil-gel resin.

4. The thermal interface material of claim 1 wherein:
the potato graphite particles have a median particle diameter D50 between about 5 micrometers and about 70 micrometers; and/or
the amount of graphite filler suspended in the matrix material is between about fifteen percent and about sixty percent by volume; and/or
the thermal interface material has a minimum thermal conductivity of about one-half W/(m·K).

5. The thermal interface material of claim 1 wherein the thermal interface material is one of:
a thermally-conductive compliant material;
a thermal interface/phase change material;
a gap filler;
a thermal putty; and
a thermal grease.

6. The thermal interface material of claim 1 wherein the graphite filler further comprises graphite particles that are not potato graphite particles.

7. The thermal interface material of claim 1 further comprising an additional filler suspended in the matrix material.

8. The thermal interface material of claim 7 wherein the additional filler includes boron nitride, alumina, zinc oxide, aluminum metal, and/or aluminum nitride.

9. The thermal interface material of claim 1 wherein the potato graphite particles include vein graphite that has been processed to make the vein graphite more spherical than before processing.

10. The thermal interface material of claim 1, wherein the potato graphite particles are substantially as shown in one or more of FIGS. 1-16.

11. An electromagnetic interference (EMI) shielding material comprising:
a matrix material; and
a graphite filler suspended in the matrix material, the graphite filler comprising potato graphite particles.

12. The EMI shielding material of claim 11 wherein the matrix material includes a resin matrix material.

13. The EMI shielding material of claim 12 wherein the resin matrix material includes a silicone resin and/or an oil-gel resin.

14. The EMI shielding material of claim 11 wherein:
the potato graphite particles have a median particle diameter D50 between about 5 and about 70 micrometers; and/or
the amount of graphite filler suspended in the matrix material is between about fifteen percent and about fifty percent by volume.

15. The EMI shielding material of claim 11 wherein the graphite filler further comprises graphite particles that are not potato graphite particles.

16. The EMI shielding material of claim 11 further comprising an additional filler suspended in the matrix material.

17. The EMI shielding material of claim 16 wherein the additional filler includes silver, nickel, silver coated glass, and/or copper coated graphite.

18. A thermally conductive and non-electrically conductive thermal interface material comprising:
a matrix material; and
a potato graphite filler suspended in the matrix material, the potato graphite filler coated with an electrically insulating coating.

19. The thermal interface material of claim 18 wherein the matrix material includes a resin matrix material.

20. The thermal interface material of claim 19 wherein the resin matrix material includes a silicone resin and/or an oil-gel resin.

21. The thermal interface material of claim 18 wherein the thermal interface material is one of:
a thermally-conductive compliant material;
a thermal interface/phase change material;
a gap filler;
a thermal putty; and
a thermal grease.

22. The thermal interface material of claim 18 further comprising an additional filler suspended in the matrix material.

23. The thermal interface material of claim 22 wherein the additional filler includes boron nitride, alumina, zinc oxide, aluminum metal, and/or aluminum nitride.

24. The thermal interface material of claim 18 wherein the electrically insulating coating is boron nitride and/or aluminum oxide.

25. The thermal interface material of claim 18 wherein:
the electrically insulating coating is thermally conductive; and/or
the thermal interface material has a minimum thermal conductivity of about one-half W/(m·K).

26. A method of manufacturing a thermal interface material, the method comprising coating potato graphite filler and suspending the coated potato graphite filler in a matrix material.

27. The method of claim 26 wherein coating the potato graphite filler includes encapsulating the potato graphite filler with the coating to limit detrimental interaction between surface impurities of the graphite filler and the matrix material.

28. The method of claim 26 wherein the thermal interface material includes an additional filler that is not coated.

29. The method of claim 28 wherein the additional filler includes boron nitride, alumina, zinc oxide, aluminum metal, and/or aluminum nitride.

30. The method of claim 28, wherein coating potato graphite filler comprises coating the potato graphite filler with one or more of boron nitride, aluminum oxide, zinc oxide, silica, calcium carbonate, aluminum trihydrate, and/or a ceramic.
